(19) United States
(12) Patent Application Publication
(10) Pub. No.: US 2012/0044531 A1
(43) Pub. Date: Feb. 23, 2012

(54) SETTING INFORMATION REGISTRATION APPARATUS, SETTING INFORMATION REGISTRATION METHOD THEREFOR, AND RECORDING MEDIUM

(75) Inventor: Hiroshi SAKAI, Sakai-shi (JP)

(73) Assignee: Konica Minolta Business Technologies, Inc., Tokyo (JP)

(21) Appl. No.: 13/196,605

(22) Filed: Aug. 2, 2011

(30) Foreign Application Priority Data
Aug. 19, 2010 (JP) 2010-184233

(51) Int. Cl. G06F 15/00

(52) U.S. Cl. 358/1.15

(57) ABSTRACT

A setting information registration apparatus is provided with: a determiner which determines the target among a plurality of first image processing apparatuses connected to the setting information registration apparatus via a network and the target among setting information objects registered on the target first image processing apparatus; a setting information obtainer which obtains the target setting information object from the target first image processing apparatus; an additional information obtainer which obtains an additional information object which is associated with the target setting information object, from the target first image processing apparatus; and a register which associates the target setting information object obtained by the setting information obtainer and the additional information object obtained by the additional information obtainer with each other, and registers them on a second image processing apparatus via the network.

This application claims priority under 35 U.S.C. §119 to Japanese Patent Application No. 2010-184233 filed on Aug. 19, 2010, the entire disclosure of which is incorporated herein by reference in its entirety.

### BACKGROUND OF THE INVENTION

1. Field of the Invention

The present invention relates to a setting information registration apparatus which is capable of registering setting information objects such as data destination addresses having been registered on a plurality of image processing apparatuses such as MFPs (Multi Function Peripherals) which are multifunctional digital image forming apparatuses, on a new image processing apparatus which is additionally connected to a network; a setting information registration method for the setting information registration apparatus; and a recording medium having a setting information registration program stored thereon to make a computer of the setting information registration apparatus implement the setting information registration method.

2. Description of the Related Art

The following description sets forth the inventor's knowledge of related art and problems therein and should not be construed as an admission of knowledge in the prior art.

In the environment where a plurality of MFPs are connected to a network, it is so common to register in advance a plurality of address information objects for data transmission on each of the MFPs so that later a target address information object can be easily selected among those registered thereon, for facsimile or e-mail transmission.

When a new MFP is additionally connected to the network, it is preferred to register the address information objects also on the new MFP.

However, it is very troublesome for administrator users or the like to enter the address information objects one by one manually.

To resolve this trouble, according to Japanese Unexamined Patent Publication No. 2007-329572, there is a technology to set up an image processing apparatus such as a MFP, automatically. More specifically, as disclosed in the Japanese Unexamined Patent Publication No. 2007-329572, an image processing apparatus having a function of communicating with multiple other image processing apparatuses via a communication circuit is provided with: an attribute information obtainer which obtains attribute information objects indicating attributes of the multiple other image forming apparatuses; a suitable setting information determiner which determines the most suitable setting information object for the image processing apparatus itself based on the obtained attribute information objects, from setting information objects indicating settings of the multiple other image forming apparatuses; a setting information obtainer which obtains the setting information object determined as being the most suitable; and a setting information register which entirely or partially applies the settings indicated by the obtained setting information object, to the image processing apparatus itself. If the new MFP is capable of performing facsimile transmission, in addition to address information objects, it is preferred to register also on the new MFP, additional information objects including job execution conditions: color modes (each indicating that the data is full-color image or monochrome image), facsimile reading resolutions, and the like.

However, no conventional technologies could serve to register such additional information objects and address information objects together, automatically.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

According to a first aspect of the present invention, a setting information registration apparatus is provided with:

a determiner which determines the target among a plurality of first image processing apparatuses connected to the setting information registration apparatus via a network and the target among setting information objects registered on the target first image processing apparatus;

a setting information obtainer which obtains the target setting information object from the target first image processing apparatus;

an additional information obtainer which obtains an additional information object which is associated with the target setting information object, from the target first image processing apparatus; and

a register which associates the target setting information object obtained by the setting information obtainer and the additional information object obtained by the additional information obtainer with each other, and registers them on a second image processing apparatus via the network.

According to a second aspect of the present invention, a setting information registration method for a setting information registration apparatus includes:

determining the target among a plurality of first image processing apparatuses connected to the setting information registration apparatus via a network, and also determining the target among setting information objects registered on the target first image processing apparatus;

obtaining the target setting information object from the target first image processing apparatus;

obtaining an additional information object which is associated with the target setting information object, from the target first image processing apparatus; and

associating the obtained target setting information object and the obtained additional information object with each other, and registering them on a second image processing apparatus via the network.

According to a third aspect of the present invention, a non-transitory computer-readable recording medium has a setting information registration program stored thereon to make a computer of a setting information registration apparatus execute:

determining the target among a plurality of first image processing apparatuses connected to the setting information registration apparatus via a network, and also determining the target among setting information objects registered on the target first image processing apparatus;

obtaining the target setting information object from the target first image processing apparatus;

obtaining an additional information object which is associated with the target setting information object, from the target first image processing apparatus; and

associating the obtained target setting information object and the obtained additional information object with each other, and registering them on a second image processing apparatus via the network.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view illustrating a configuration of a network registration system in which a setting information registration apparatus according to one mode of implementing the present invention is employed;

FIG. 2 is a block diagram illustrating a functional configuration of the setting information registration apparatus and MFPs;

FIG. 3 is a view to explain the overview of the operations of the setting information registration apparatus;

FIG. 4 is a view illustrating one example of a log information object;

FIG. 5 is a view illustrating one example of a setting information object;

FIG. 6 is a view illustrating one example of an additional information object;

FIG. 7 is a view illustrating one example of an additional information object and a setting information object which are associated with each other;

FIG. 8 is a view to explain how to adjust an additional information object;

FIG. 9 is a view to explain how to adjust additional information objects, if more than one additional information item is predetermined to be registered on the MFP 5;

FIG. 10 is a flowchart representing a processing routine executed by the setting information registration apparatus and the image processing apparatuses; and

FIG. 11 is a flowchart representing a processing routine executed by the setting information registration apparatus to generate a target additional information object as previously explained with reference to FIG. 9.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one mode of implementing the present invention will be described with reference to the accompanying drawings.

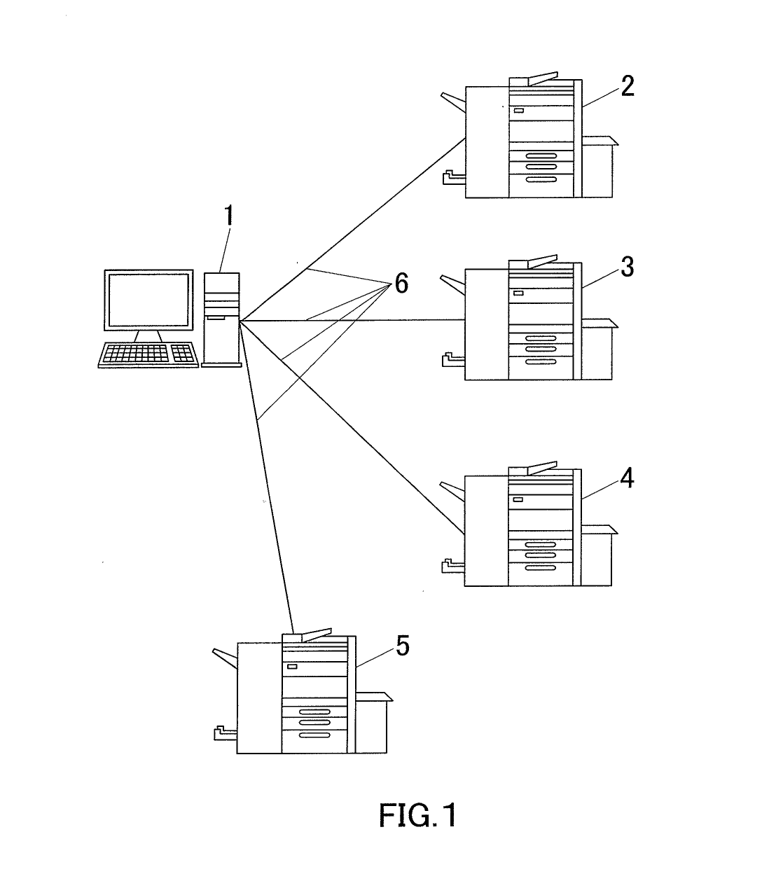

FIG. 1 is a view illustrating a configuration of a network registration system in which a setting information registration apparatus according to one mode of implementing the present invention is employed.

As illustrated in FIG. 1, this network registration system is provided with a setting information registration apparatus 1 and multiple MFPs also referred to as multifunctional digital image forming apparatuses each serving as an image processing apparatus, MFPs 2 to 5, which are connected to each other via a network 6 such as LAN.

In this mode of embodied implementation: the MFPs 2, 3, and 4 have been used in the network 6, having their own setting information objects registered in advance; the MFP 5 is a new MFP additionally connected to the network 6, not having its own setting information objects registered yet. In this mode of embodied implementation: the setting information objects are address information objects for facsimile (hereinafter also will be referred to as FAX) transmission; however, the setting information objects are not limited to address information objects for facsimile transmission, and these alternatively may be address information objects for e-mail transmission or workflows each consisting of a sequence of tasks.

The setting information registration apparatus 1 has a function of obtaining the address information objects from the MFPs 2, 3, and 4 having them registered in advance and a function of registering the obtained address information objects on the MFP 5; the setting information registration apparatus 1 is constituted by a computer.

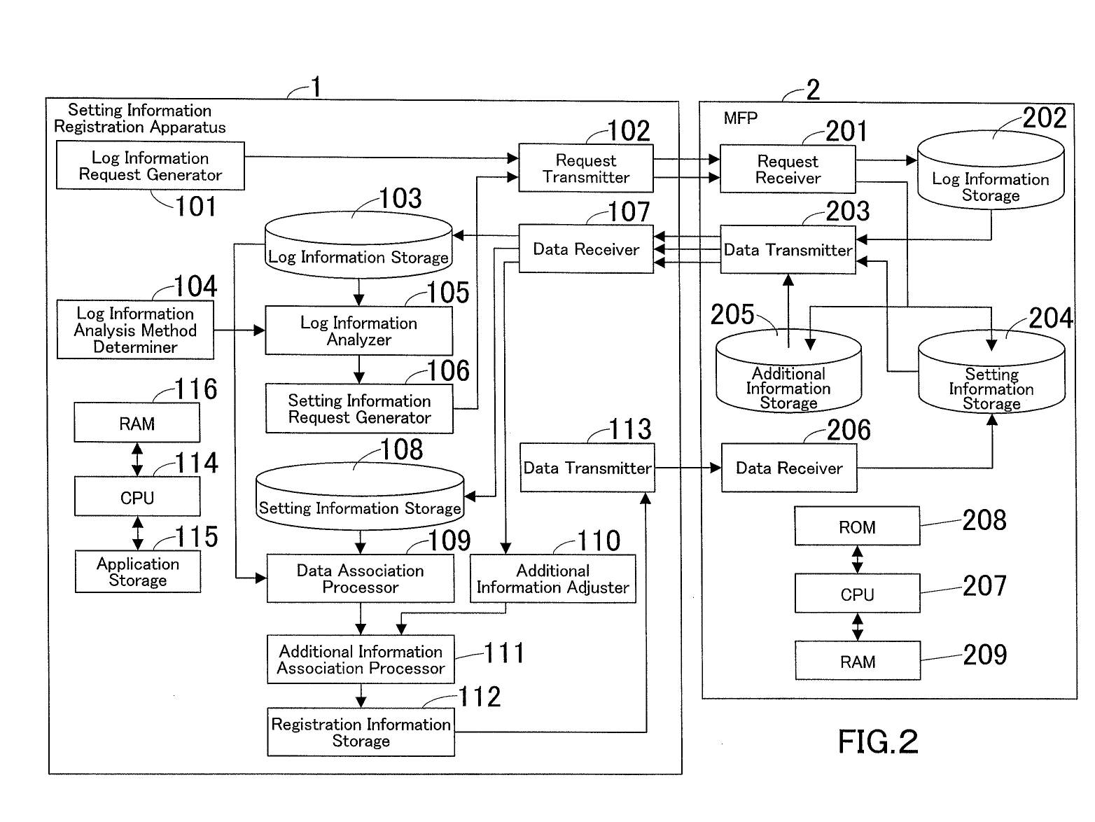

FIG. 2 is a block diagram illustrating a functional configuration of the setting information registration apparatus 1 and the MFPs 2 to 5. The MFPs 2 to 5 commonly have a certain configuration; hereinbelow, the MFP 2 will be described as an example of the MFPs.

The setting information registration apparatus 1 is provided with a log information request generator 101, a request transmitter 102, a log information storage 103, a log information analysis method determiner 104, a log information analyzer 105, a setting information request generator 106, a data receiver 107, a setting information storage 108, a data association processor 109, an additional information adjuster 110, an additional information association processor 111, a registration information storage 112, a data transmitter 113, a CPU 114, an application storage 115, a RAM 116, and the like.

The log information request generator 101 generates a request for a log information object to the MFPs 2 to 4, and the request transmitter 102 serves as an interface to transmit the request generated by the log information request generator 101, to the MFPs 2 to 4.

The log information storage 103 is a recording medium which stores the log information objects obtained from the MFPs 2 to 4, for example a hard disk drive.

The log information analysis method determiner 104 determines the analysis method by which an analysis should be performed on the log information objects, and the log information analyzer 105 performs an analysis on the log information objects by the determined method.

The setting information request generator 106 identifies the MFP from which a address information object should be obtained and the address information object, according to the analysis result obtained by the log information analyzer 105; generates a request for a address information object such as a facsimile number or the like; and makes the request transmitter 102 transmit the generated request to the identified MFP.

The data receiver 107 serves as an interface to receive information from the MFPs 2 to 4.

The setting information storage 108 stores setting information objects which are the address information objects received from the MFPs 2 to 4 by the data receiver.

The data association processor 109 associates the results obtained by the log information analyzer 105 and the address information objects with each other.

The additional information adjuster 110 obtains additional information objects which are the job execution conditions associated with the address information objects for example, via the data receiver 107. And if the obtained job execution conditions are not suitable for the MFP 5 in terms of its capability, the additional information adjuster 110 adjusts the job execution conditions.

The additional information association processor 111 generates a registration information object by further associating the results obtained by the log information analyzer 105 and the address information objects which are associated with each other by the data association processor 109, to the additional information objects obtained and adjusted by the additional information adjuster 110.

The registration information storage 112 stores the registration information object generated by the additional information association processor 111; the data transmitter 113 transmits the registration information object stored on the registration information storage 112 to the MFP 5, a new MFP additionally connected to the network 6.

The CPU 114 integrally controls the entire setting information registration apparatus 1; the log information request generator 101, the log information analysis method determiner 104, the log information analyzer 105, the setting information request generator 106, the data association processor 109, the additional information adjuster 110, the additional information association processor 111, and the like partially constitute the features of the CPU 114.

The application storage 115 stores an application program and other data for the CPU 114 to perform the operations, from obtaining log information objects until transmitting a registration instruction to the MFP 5.

The RAM 116 provides a work area for the CPU 114 to perform the operations according to an application program stored on the application storage 115.

The MFP 2 is provided with: a request receiver 201, a log information storage 202, a data transmitter 203, a setting information storage 204, an additional information storage 205, a data receiver 206, a CPU 207, a ROM 208, a RAM 209, and the like.

The request receiver 201 serves as an interface to receive a request and the like from the setting information registration apparatus 1; the log information storage 202 stores the log information object of the MFP 2 itself; the data transmitter 203 serves as an interface to transmit the information owned by the MFP 2 to the setting information registration apparatus 1 and the like.

The setting information storage 204, which constitutes a hard disk drive for example, stores FAX destination addresses and other setting information objects.

The additional information storage 205 stores the machine information of the MFP 2 and additional information objects including job execution conditions: destination addresses; resolutions applied when data is transmitted to the destination addresses; and color modes each indicating that the data is full-color image or monochrome image, and other information.

The data receiver 206 serves as an interface to receive the registration information object to be transmitted to the MFP 5 from the setting information registration apparatus 1.

The CPU 207 integrally controls the entire MFP 2; the ROM 208 stores operation programs for the CPU 207. The RAM 209 provides a work area for the CPU 207 to execute processing according to an operation program stored on a recording medium such as the ROM 208.

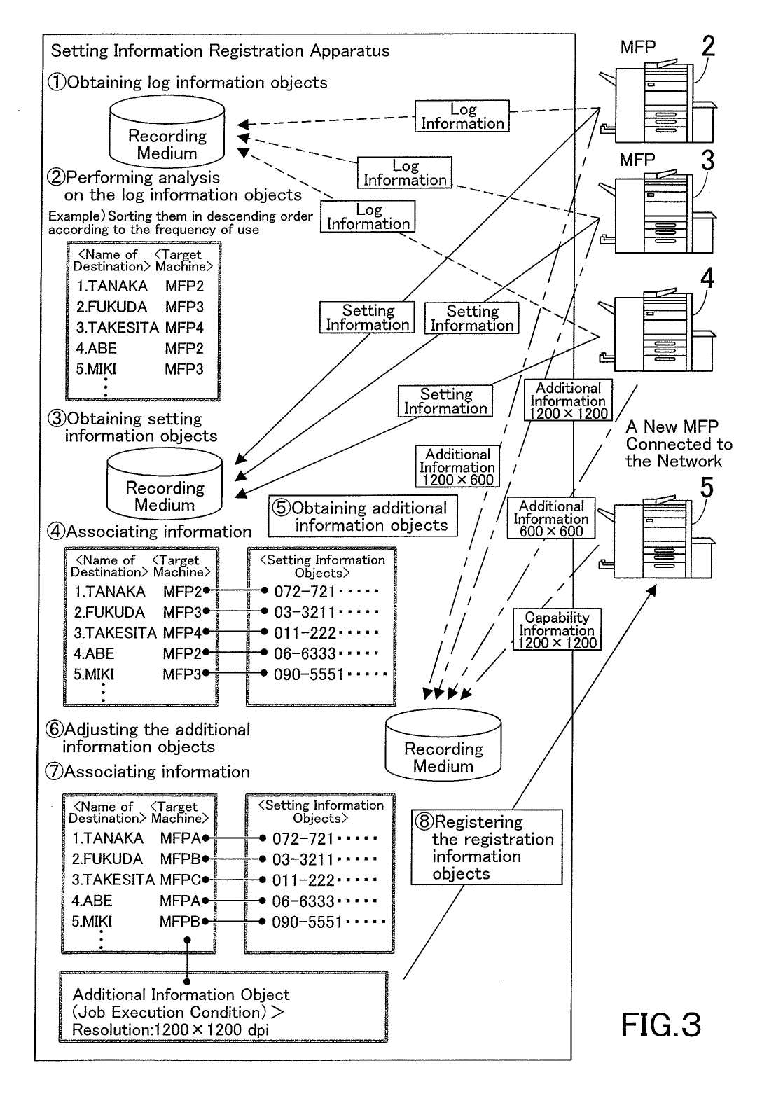

Hereinafter, the overview of the operations of the setting information registration apparatus 1 will be described with reference to FIGS. 3 to 8.

The MFPs 2 to 4 have a plurality of setting information objects registered in advance, which are associated with names of FAX destinations and FAX numbers. The MFPs 2 to 4 also have their own log information objects cumulatively stored thereon.

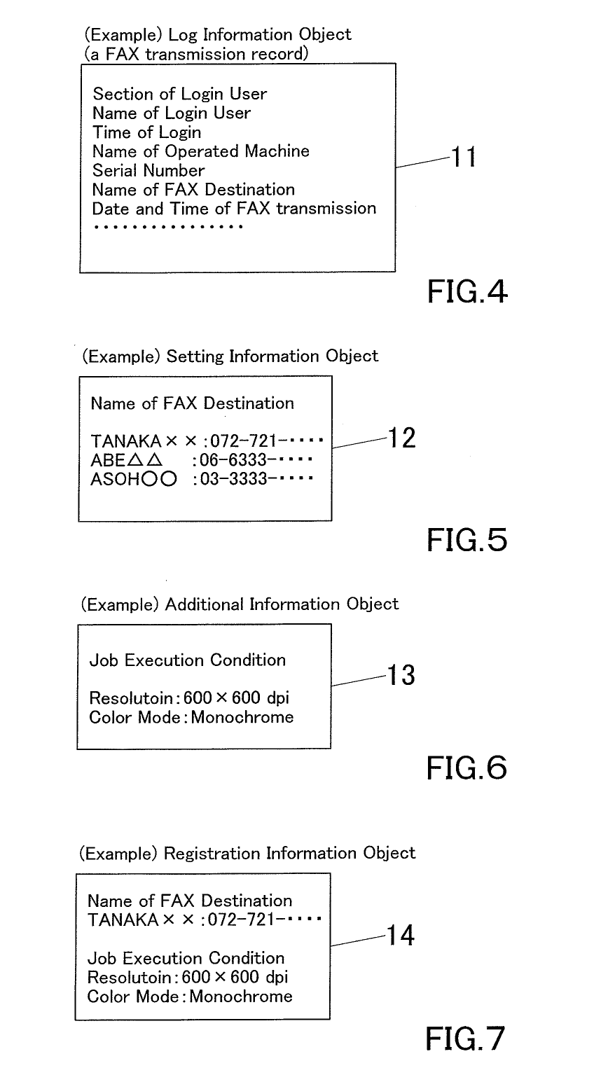

Initially, the setting information registration apparatus 1 obtains from the MFPs 2 to 4, the log information objects relating to FAX transmission, and stores them as text data or binary data on a recording medium (circled number 1 of FIG. 3). FIG. 4 is a view illustrating one example of a log information object 11 relating to FAX transmission. The log information object 11 includes section of login user, name of login user, time of login, name of operated machine (MFP), serial number, name of FAX destination, date and time of FAX transmission, and the like.

Back to FIG. 3, the setting information registration apparatus 1 then performs analysis on the obtained log information objects (circled number 2 of FIG. 3). In this mode of embodied implementation, pairs of name of FAX destination and name of operated MFP (referred to as “Target Machine” in FIG. 3) are sorted in descending order according to the frequency of use.

In order to identify the FAX numbers associated with the names of FAX destinations, the setting information registration apparatus 1 obtains from the MFPs 2 to 4, setting information objects which are FAX destination addresses, and stores them as text data or binary data on the recording medium (circled number 3 of FIG. 3).

Here, the item “Target Machine” in the sorted list serves to identify the target MFPs from which setting information objects should be obtained. The item “Name of Destination” in the sorted list serves to identify the target address information object which should be obtained. Subsequently, the setting information registration apparatus 1 transmits a request for the identified setting information object to the identified MPFs, the MPFs 2 to 4.

FIG. 5 is a view illustrating one example of a setting information object 12 obtained from the MFPs 2 to 4. The setting information object 12 includes one name of destination and its matching FAX number or a plurality of names of destinations and their matching FAX numbers.

Back to FIG. 3, the setting information registration apparatus 1 then associates the setting information objects 12 obtained from the MFPs 2 to 4 with the pairs of name of FAX destination and name of operated MFP which are sorted in descending order according to the frequency of use (circled number 4 of FIG. 3). The setting information registration apparatus 1 may perform that association process by additionally writing the setting information objects 12 in the text data, or by giving a common ID to relevant files.

Subsequently, the setting information registration apparatus 1 obtains from the MFPs 2 to 4, the additional information objects associated with the setting information objects 12 (address information objects) and stored on the MFPs 2 to 4, and stores them as text data or binary data on the recording medium (circled number 5 of FIG. 3). Also, the setting information registration apparatus 1 obtains from the MFP 5, the performance information of the MFP 5, and stores it as text data or binary data on the recording medium.

FIG. 6 is a view illustrating one example of an additional information object 13. In this example, the additional information object 13 indicates job execution conditions such as a color mode and a facsimile reading resolution, but it is not limited thereto. For example, the additional information object 13 may be a speed dialing FAX number, a digital signature (S/MIME) certificate, information to display an icon representing a address information object to be registered, or the like.

Back to FIG. 3, the setting information registration apparatus 1 then generates the most suitable additional information objects based on the additional information objects obtained from the MFPs 2 to 4 and the capability of the MFP 5 (circled number 6 of FIG. 3). The process of generating the target additional information objects later will be described in detail.

Subsequently, the setting information registration apparatus 1 associates the most suitable additional information objects with the pairs of name of FAX destination and name of operated MFP which are associated with the setting information objects as indicated by the circled number 4 of FIG. 3, to generate registration information objects to be registered on the MFP 5 (circled number 7 of FIG. 3). The setting information registration apparatus 1 may perform that association process by additionally writing the additional information objects in the text data, or by giving a common ID to relevant files.

FIG. 7 is a view illustrating one example of an additional information object and a setting information object which are associated with each other (one example of a registration information object 14 to be registered on the MFP 5).

Back to FIG. 3, the setting information registration apparatus 1 then transmits the generated registration information objects 14 to the MFP 5, to register them thereon (circled number 8 of FIG. 3). In this way, additional information objects and setting information objects are both automatically registered on the MFP 5, a new MFP additionally connected to the network.

In this mode of embodied implementation, the names of operated MFPs are sorted in descending order according to the frequency of use, and setting information objects are obtained from the MFPs. The MFPs from which setting information objects are obtained may be limited to a certain number, for example, setting information objects may be obtained only from as many as one hundred MFPs which are listed from the top of the list in descending order according to the frequency of use. This means, the target information objects including the setting information objects obtained from the MFPs which have been used more frequently would be preferentially registered on the MFP 5, which improves the usefulness. Or only the target information objects including the setting information objects obtained from the MFPs which have been used more frequently just during a certain period of time would be preferentially registered on the MFP 5. In other words, only the target information objects including the setting information objects obtained from the MFPs which have been used more frequently but have not been used at all for recent months or years would be preferentially registered on the MFP 5, which further improves the usefulness. Or only the target information objects including the setting information objects obtained from the MFPs which have been used at least once just during a certain period of time would be preferentially registered on the MFP 5.

The MFPs from which setting information objects are obtained may be limited to a certain number or range by users, for example, the setting information registration apparatus 1 may obtain setting information objects only from the MFPs specified by users.

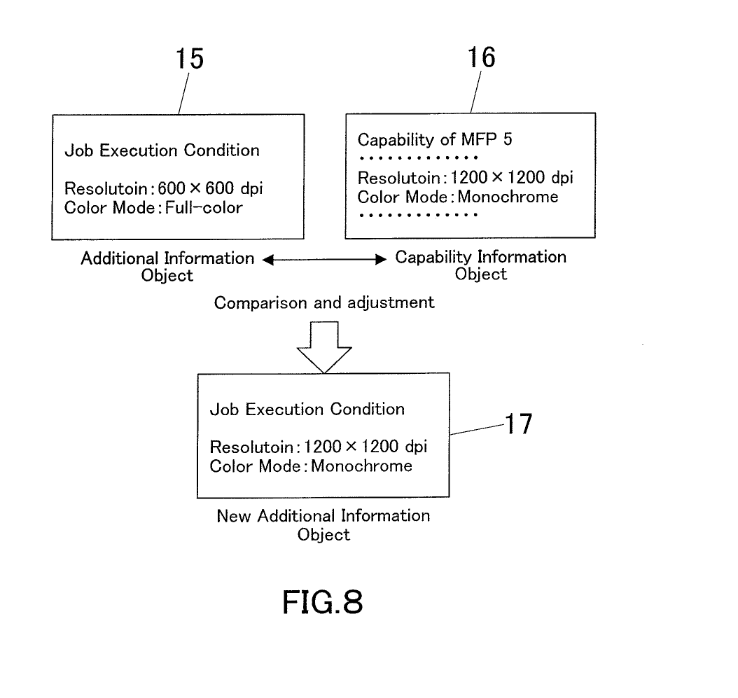

Hereinafter, the process of generating the most suitable additional information objects as indicated by the circled number 6 of FIG. 3 will be described with reference to FIG. 8.

As illustrated in FIG. 8, the additional information object 15 obtained from the MFPs 2 to 4 indicates the following job execution conditions: 600×600 dpi resolution and full-color mode, and a capability information object 16 obtained from the MFP 5 indicates 1200×1200 dpi resolution and monochrome mode. In such a case, it is preferred to register the resolution of the MFP 5, 1200×1200 dpi, on the MFP 5, because both of the resolutions are available on the MFP 5.

However, it is not preferred to register the color mode indicated by the additional information object 15 obtained from the MFPs 2 to 4, full-color mode, on the MFP 5, because it is not available on the MFP 5.

Therefore, a new additional information object 17 with the following job execution conditions: 1200×1200 dpi resolution and monochrome mode is generated. And this is associated with the setting information object obtained from the MFPs 2 to 4, and registered on the MFP 5.

By properly adjusting the additional information object in this way above, the setting information registration apparatus 1 can eliminate the conflict caused by the difference in capability between the MFPs.

Users may specify a job execution condition not exceeding the capability of the MFP 5. For example, users may specify a resolution equal to or lower than 1200×1200 dpi resolution via a screen displayed on the MFP 2. In this case, users' intentions can be reflected to the settings.

Briefly describing the process of FIG. 8, if a job execution condition being included in the additional information object 15 obtained from the MFPs 2 to 4 exceeds the performance value of the MFP 5, a new MFP additionally connected to the network, the performance value of the MFP 5 is registered on the MFP 5 as an additional information object; if a job execution condition being included in the additional information object 15 obtained from the MFPs 2 to 4 does not exceed the performance value of the MFP 5, the performance value of the MFP 5 or a user's specified job execution condition not exceeding the capability of the MFP 5 is registered on the MFP 5. If a job execution condition being included in the additional information object 15 obtained from the MFPs 2 to 4 corresponds to the performance value of the MFP 5, the additional information object 15 is registered on the MFP 5.

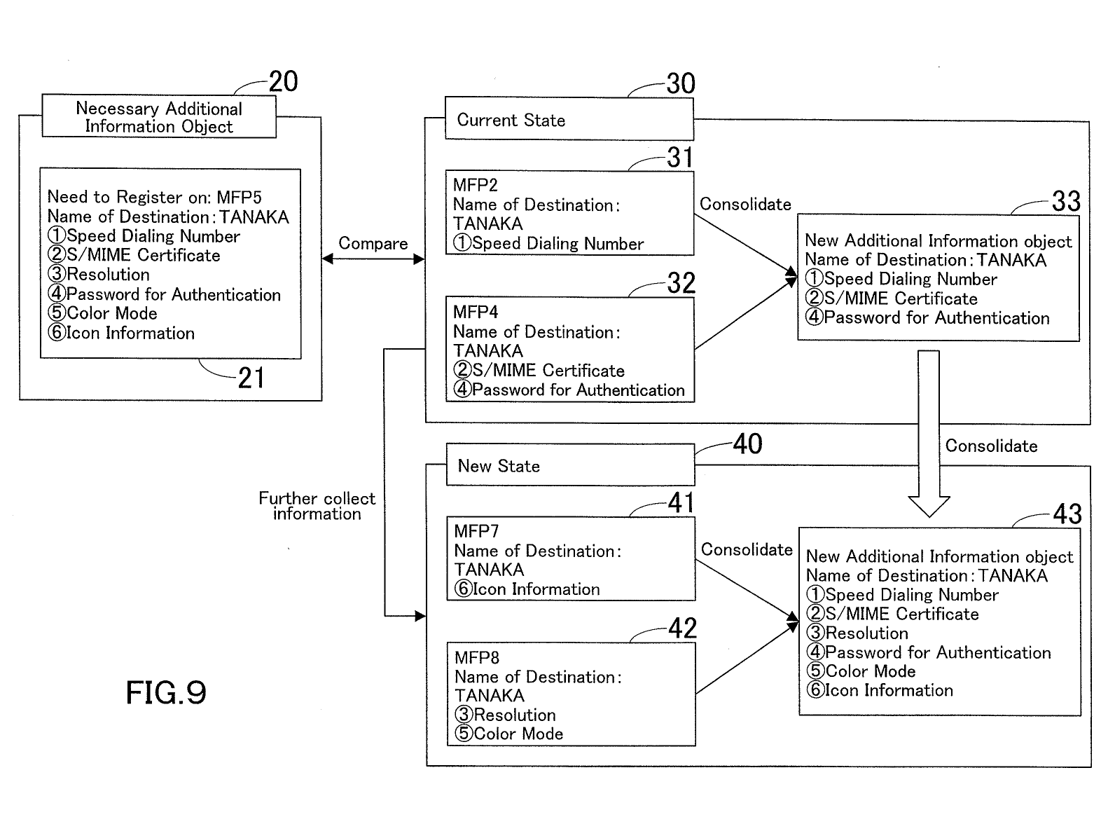

FIG. 9 is a view to explain how to adjust additional information objects, if more than one additional information item is predetermined to be registered on the MFP 5.

As illustrated in FIG. 9, a necessary additional information object 20 is associated with the target setting information object with the name of destination “TANAKA” to be registered on the MFP 5, and it includes the following additional information items: speed dialing number, S/MIME certificate, resolution, password for authorization, color mode, and information to display an icon, which are all predetermined.

The setting information registration apparatus 1 collects additional information objects from all the MFPs including the target MFP from which the target setting information object is received, so as to fill in all the additional information items with.

For example, as illustrated in a current state 30, obtaining an additional information object 31 including a “speed dialing number” from the MFP 2 and an additional information object 32 including a “S/MIME certificate” and a “password for authentication” from the MFP 4, the setting information registration apparatus 1 generates a new additional information object 33 by consolidating the additional information objects 32 and 33. And the setting information registration apparatus 1 compares the consolidated additional information object 33 to the necessary additional information object 20.

And as illustrated in a new state 40, if the comparison results reveal that the consolidated additional information object 33 is not sufficient, the setting information registration apparatus 1 obtains from MFPs 7 and 8 (not illustrated in the Figure) the missing additional information objects, additional information objects 41 and 42, so as to fill in the blank additional information items. Then, the setting information registration apparatus 1 generates a new additional information object 43 by further consolidating the consolidated additional information object 33 and the additional information objects 41 and 42 obtained from the MFPs 7 and 8.

If all the additional information items necessary for the MFP 5 cannot be filled even by obtaining additional information objects from all the MFPs connected to the network, the target additional information object 43 is registered on the MFP 5 with the blank additional information items.

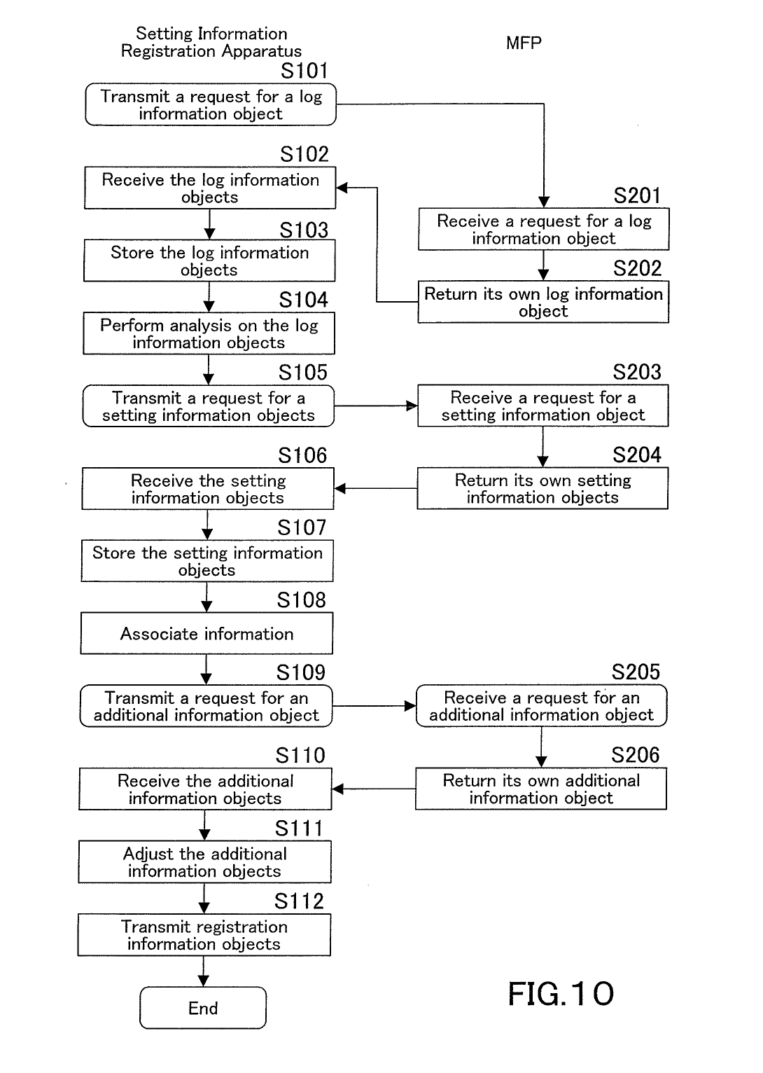

FIG. 10 is a flowchart representing a processing routine executed by the setting information registration apparatus 1 and the MFPs 2 to 4.

The processing routine of the setting information registration apparatus 1 is executed by the CPU 114 of the setting information registration apparatus 1 according to an application program stored on a recording medium such as the application storage 115.

In Step S101, the setting information registration apparatus 1 transmits a request for a log information object to the MFPs 2 to 4. Receiving the request in Step S201, the MFPs 2 to 4 return their log information objects to the setting information registration apparatus 1 in Step S202.

The setting information registration apparatus 1 receives the log information objects in Step S102, and stores them in Step S103.

Subsequently, the setting information registration apparatus 1 performs an analysis process on the log information objects, which includes for example: sorting the log information objects in descending order according to the frequency of use as previously described; extracting the operations logs having been used at least once just during a certain period of time; and determining the target MFP and the target setting information object, and then in Step S105, transmits an request for the target setting information object to the target MFP.

Receiving the request in Step S203, the MFPs 2 to 4 return their setting information objects to the setting information registration apparatus 1 in Step S204.

The setting information registration apparatus 1 receives the setting information objects in Step S106, and stores them in Step S107. Subsequently, the setting information registration apparatus 1 associates the setting information objects with their matching names of destinations for example, in Step S108, and transmits a request for an additional information object to all the MFPs 2 to 4 in Step S109.

Receiving the request in Step S205, the MFPs 2 to 4 return their additional information objects to the setting information registration apparatus 1 in Step S206.

The setting information registration apparatus 1 receives the additional information objects in Step S110, and generates registration information objects by adjusting them and associating them with the setting information objects in Step S111. And the setting information registration apparatus 1 transmits the generated registration information objects to the MFP 5 to register thereon, in Step S112.

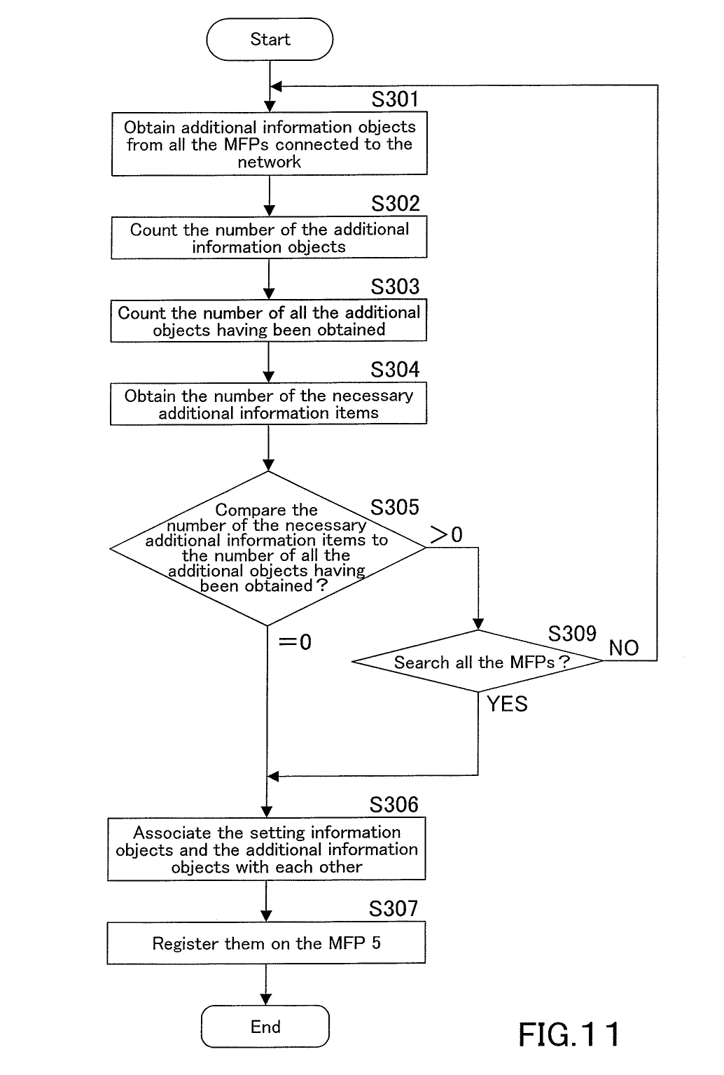

FIG. 11 is a flowchart representing the processing routine executed by the setting information registration apparatus 1 to generate a target additional information object as previously explained with reference to FIG. 9.

The processing routine of the setting information registration apparatus 1 is executed by the CPU 114 of the setting information registration apparatus 1 according to an application program stored on a recording medium such as the application storage 115.

In Step S301, additional information objects are obtained from the all MFPs 2 to 4 connected to the network. Then, the number of the additional information objects is counted in Step S302, and the number of all the additional information objects having been obtained is counted in Step S303.

The number of the necessary additional information items is obtained from the MFP 5 in Step S304, and the number of the necessary additional information items and the number of all the additional information objects having been obtained are compared to each other in Step S305. In other words, it is judged whether or not all the necessary additional information items are filled with the additional information objects.

If all the necessary additional information items are filled (“=0” in Step S305), the routine proceeds to Step S306. It there are some blank necessary additional information items (“>0” in Step S305), the routine proceeds to Step S309, in which it is judged whether or not all the MFPs connected to the network are searched for their additional information objects. If all the MFPs are not searched yet (NO in Step S309), the routine goes back to Step S301 to continue the process of obtaining additional information objects. If all the MFPs are searched (YES in Step S309), the routine proceeds to Step S306.

And then, registration information objects are generated by associating the setting information objects and the additional information objects with each other in Step S306, and transmitted to the MFP 5 to be registered thereon in Step S307.

The modes of implementing the present invention have been described in the foregoing specification, which does not mean that the present invention shall be construed as limited to the particular forms disclosed. For example, in the mode of embodied implementation, the setting information objects (address information objects) are obtained from the MFPs

The present invention of the subject application having been described above can be applied to the following modes:

[1] A setting information registration apparatus which is provided with:

a determiner which determines the target among a plurality of first image processing apparatuses connected to the setting information registration apparatus via a network and the target among setting information objects registered on the target first image processing apparatus;

a setting information obtainer which obtains the target setting information object from the target first image processing apparatus;

an additional information obtainer which obtains an additional information object which is associated with the target setting information object, from the target first image processing apparatus; and

a register which associates the target setting information object obtained by the setting information obtainer and the additional information object obtained by the additional information obtainer with each other, and registers them on a second image processing apparatus via the network.

[2] The setting information registration apparatus as recited in the aforementioned item [1], which is further provided with:

a log information obtainer which obtains log information objects from the first image processing apparatuses; and

an analyzer which analyzes the log information objects obtained by the log information obtainer,

wherein the determiner determines the target first image processing apparatus and the target setting information object based on the results obtained by the analyzer.

[3] The setting information registration apparatus as recited in the aforementioned item [2], wherein determiner determines as the targets, the first image processing apparatus which holds a log information object with a more recent date and time and/or a higher frequency of use and the setting information object which is associated with the log information object with a more recent data and time and/or a higher frequency of use, based on the results obtained by the analyzer.

[4] The setting information registration apparatus as recited in the aforementioned item [1], wherein the determiner determines the target setting information object according to user instructions.

[5] The setting information registration apparatus as recited in the aforementioned item [1], wherein an additional information item is predetermined as the target, and the additional information obtainer obtains the additional information object which is written in the target additional information item, from the target first image processing apparatus.

[6] The setting information registration apparatus as recited in the aforementioned item [1], wherein the obtained target setting information object is a destination address to which data is to be transmitted for job execution, and the obtained additional information object includes at least a job execution condition based on the capability of the target first image processing apparatus, under which job execution is performed on the data to be transmitted to the destination address.

[7] The setting information registration apparatus as recited in the aforementioned item [6], which is further provided with a job execution condition adjuster which adjusts the job execution condition being included in the target setting information object obtained from the target first image processing apparatus, so that the adjusted job execution condition and the obtained target setting information object both can be registered as an additional information object on the second image processing apparatus if the job execution condition being included in the target setting information object obtained from the target first image processing apparatus is not identical with a job execution condition based on the capability of the second image processing apparatus.

[8] The setting information registration apparatus as recited in the aforementioned item [7], wherein the job execution condition adjuster further adjusts the adjusted job execution condition as an additional information object on the second information processing apparatus, if the job execution condition being included in the target setting information object obtained from the target first image processing apparatus is not identical with the job execution condition based on the capability of the second image processing apparatus.

[9] The setting information registration apparatus as recited in the aforementioned item [7], wherein the job execution condition generator further registers a user's specified job execution condition not exceeding the capability of the second image processing apparatus, as an additional information object on the second image processing apparatus, if the job execution condition being included in the target setting information object obtained from the target first image processing apparatus is not identical with the job execution condition based on the capability of the second image processing apparatus.

[10] The setting information registration apparatus as recited in the aforementioned item [1], wherein the setting information obtainer obtains the target setting information object from an LDAP server connected to the network, if it is not registered on the target first image processing apparatus.

[11] A setting information registration method for a setting information registration apparatus, including:

determining the target among a plurality of first image processing apparatuses connected to the setting information registration apparatus via a network, and also determining the target among setting information objects registered on the target first image processing apparatus;

obtaining the target setting information object from the target first image processing apparatus;

obtaining an additional information object which is associated with the target setting information object, from the target first image processing apparatus; and

associating the obtained target setting information object and the obtained additional information object with each other, and registering them on a second image processing apparatus via the network.

[12] A non-transitory computer-readable recording medium having a setting information registration program stored thereon to make a computer of a setting information registration apparatus execute:

determining the target among a plurality of first image processing apparatuses connected to the setting information registration apparatus via a network, and also determining the target among setting information objects registered on the target first image processing apparatus;

obtaining the target setting information object from the target first image processing apparatus;

obtaining an additional information object which is associated with the target setting information object, from the target first image processing apparatus; and

associating the obtained target setting information object and the obtained additional information object with each other, and registering them on a second image processing apparatus via the network.

With the mode of embodied implementation as recited in the aforementioned item [1], the target is determined among a plurality of first image processing apparatuses connected to the network, and the target is determined among setting information objects registered on the target first image processing apparatus. And the target setting information object and an additional information object associated therewith are both obtained from the target first image processing apparatus, then registered on the second image processing apparatus via the network. In this way, the setting information registration apparatus automatically registers a setting information object and an additional information object both on a new image processing apparatus which is additionally connected to the network, which is very practical and useful.

With the mode of embodied implementation as recited in the aforementioned item [2], log information objects are obtained from the first image processing apparatuses, then analyzed; the target first image processing apparatus and the target setting information object are determined based on the results of the analysis. In this way, by analyzing the log information objects, a setting information object with a higher frequency of use is registered on the second image processing apparatus.

With the mode of embodied implementation as recited in the aforementioned item [3], the target setting information object, which is associated with an log information object with a more recent data and time and/or a higher frequency of use, is obtained from the target first image processing apparatus, which holds the log information object with a more recent date and time and/or a higher frequency of use. In this way, a setting information object with a more recent data and time and/or a higher frequency of use is registered on the second image processing apparatus.

With the mode of embodied implementation as recited in the aforementioned item [4], a user's specified setting information object is registered on the second image processing apparatus.

With the mode of embodied implementation as recited in the aforementioned item [5], an additional information object which is written in a predetermined additional information item is obtained from the target first image processing apparatus.

With the mode of embodied implementation as recited in the aforementioned item [6], a job execution condition based on the capability of the target first image processing apparatus and a destination address to which data is to be transmitted for job execution are both automatically registered on the second image processing apparatus.

With the mode of embodied implementation as recited in the aforementioned item [7], the job execution condition being included in the target setting information object obtained from the target first image processing apparatus is adjusted if it is not identical with a job execution condition based on the capability of the second image processing apparatus. In this way, the inconvenience that a job execution condition exceeding the capability of the second image processing apparatus is uselessly registered on the second image processing apparatus can be eliminated.

With the mode of embodied implementation as recited in the aforementioned item [8], a job execution condition based on the capability of the second image processing apparatus is registered on the second image processing apparatus if the job execution condition being included in the target setting information object obtained from the target first image processing apparatus is not identical with the job execution condition based on the capability of the second information processing apparatus. In this way, the inconvenience that an unsuitable job execution condition is uselessly registered thereon can be eliminated.

With the mode of embodied implementation as recited in the aforementioned item [9], a user's specified job execution condition not exceeding the capability of the second image processing apparatus is registered on the second image processing apparatus if the job execution condition being included in the target setting information object obtained from the target first image processing apparatus is not identical with the job execution condition based on the capability of the second information processing apparatus.

With the mode of embodied implementation as recited in the aforementioned item [10], if the target setting information object is not registered on the target first image processing apparatus, it is obtained from an LDAP (Lightweight Directory Access Protocol) server.

With the mode of embodied implementation as recited in the aforementioned item [11], the target setting information object and an additional information object associated therewith are both registered on the second image processing apparatus, automatically.

With the mode of embodied implementation as recited in the aforementioned item [12], a computer of the image processing apparatus performs the process of registering the target setting information object and an additional information object associated therewith, both on the second image processing apparatus, automatically.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A setting information registration apparatus comprising:
a determiner which determines the target among a plurality of first image processing apparatuses connected to the setting information registration apparatus via a network and the target among setting information objects registered on the target first image processing apparatus;
a setting information obtainer which obtains the target setting information object from the target first image processing apparatus;
an additional information obtainer which obtains an additional information object which is associated with the target setting information object, from the target first image processing apparatus; and
a register which associates the target setting information object obtained by the setting information obtainer and the additional information object obtained by the additional information obtainer with each other, and registers them on a second image processing apparatus via the network.

2. The setting information registration apparatus as recited in claim 1, further comprising:
a log information obtainer which obtains log information objects from the first image processing apparatuses; and
an analyzer which analyzes the log information objects obtained by the log information obtainer,
wherein the determiner determines the target first image processing apparatus and the target setting information object based on the results obtained by the analyzer.

3. The setting information registration apparatus as recited in claim 2, wherein the determiner determines as the targets, the first image processing apparatus which hold a log information object with a more recent date and time and/or a higher frequency of use and the setting information object which is associated with the log information object with a more recent data and time and/or a higher frequency of use, based on the results obtained by the analyzer.

4. The setting information registration apparatus as recited in claim 1, wherein the determiner determines the target setting information object according to user instructions.

5. The setting information registration apparatus as recited in claim 1, wherein an additional information item is predetermined as the target, and the additional information obtainer obtains the additional information object which is written in the target additional information item, from the target first image processing apparatus.

6. The setting information registration apparatus as recited in claim 1, wherein the obtained target setting information object is a destination address to which data is to be transmitted for job execution, and the obtained additional information object includes at least a job execution condition based on the capability of the target first image processing apparatus, under which job execution is performed on the data to be transmitted to the destination address.

7. The setting information registration apparatus as recited in claim 6, further comprising a job execution condition adjuster which adjusts the job execution condition being included in the target setting information object obtained from the target first image processing apparatus, so that the adjusted job execution condition and the obtained target setting information object both can be registered as an additional information object on the second image processing apparatus if the job execution condition being included in the target setting information object obtained from the target first image processing apparatus is not identical with a job execution condition based on the capability of the second image processing apparatus.

8. The setting information registration apparatus as recited in claim 7, wherein the job execution condition adjuster further adjusts the adjusted job execution condition as an additional information object on the second information processing apparatus, if the job execution condition being included in the target setting information object obtained from the target first image processing apparatus is not identical with the job execution condition based on the capability of the second image processing apparatus.

9. The setting information registration apparatus as recited in claim 7, wherein the job execution condition generator further registers a user's specified job execution condition not exceeding the capability of the second image processing apparatus, as an additional information object on the second image processing apparatus, if the job execution condition being included in the target setting information object obtained from the target first image processing apparatus is not identical with the job execution condition based on the capability of the second image processing apparatus.

10. The setting information registration apparatus as recited in claim 1, wherein the setting information obtainer obtains the target setting information object from an LDAP server connected to the network, if it is not registered on the target first image processing apparatus.

11. A setting information registration method for a setting information registration apparatus, comprising:
determining the target among a plurality of first image processing apparatuses connected to the setting information registration apparatus via a network, and also determining the target among setting information objects registered on the target first image processing apparatus;
obtaining the target setting information object from the target first image processing apparatus;
obtaining an additional information object which is associated with the target setting information object, from the target first image processing apparatus; and
associating the obtained target setting information object and the obtained additional information object with each other, and registering them on a second image processing apparatus via the network.

12. The setting information registration method for a setting information registration apparatus as recited in claim 11, further comprising:
obtaining log information objects from the first image processing apparatuses; and
analyzing the obtained log information objects,
wherein the target first image processing apparatus and the target setting information object are determined based on the analysis results.

13. A non-transitory computer-readable recording medium having a setting information registration program stored thereon to make a computer of a setting information registration apparatus execute:
determining the target among a plurality of first image processing apparatuses connected to the setting information registration apparatus via a network, and also determining the target among setting information objects registered on the target first image processing apparatus;
obtaining the target setting information object from the target first image processing apparatus;
obtaining an additional information object which is associated with the target setting information object, from the target first image processing apparatus; and
associating the obtained target setting information object and the obtained additional information object with each other, and registering them on a second image processing apparatus via the network.

14. The non-transitory computer-readable recording medium as recited in claim 13, having a setting information registration program stored thereon to make the computer further execute:
obtaining log information objects from the first image processing apparatuses; and
analyzing the obtained log information objects,
wherein the target first image processing apparatus and the target setting information object are determined based on the analysis results.

15. The non-transitory computer-readable recording medium as recited in claim 14, having a setting information registration program stored thereon, wherein the first image processing apparatus which hold a log information object with a more recent date and time and/or a higher frequency of use and the setting information object which is associated with the log information object with a more recent data and time and/or a higher frequency of use are determined as the targets based on the results obtained by the analyzer.

16. The non-transitory computer-readable recording medium as recited in claim 13, having a setting information registration program stored thereon, wherein the target setting information object is determined according to user instructions.

17. The non-transitory computer-readable recording medium as recited in claim 13, having a setting information registration program stored thereon, wherein an additional information item is predetermined as the target, and the additional information object which is written in the target additional information item is obtained from the target first image processing apparatus.

18. The non-transitory computer-readable recording medium as recited in claim 13, having a setting information registration program stored thereon, wherein the obtained target setting information object is a destination address to which data is to be transmitted for job execution, and the obtained additional information object includes at least a job execution condition based on the capability of the target first image processing apparatus, under which job execution is performed on the data to be transmitted to the destination address.

19. The non-transitory computer-readable recording medium as recited in claim 18, having a setting information registration program stored thereon to make the computer further execute adjusting the job execution condition being included in the target setting information object obtained from the target first image processing apparatus, so that the adjusted job execution condition and the obtained target setting information object both can be registered as an additional information object on the second image processing apparatus if the job execution condition being included in the target setting information object obtained from the target first image processing apparatus is not identical with a job execution condition based on the capability of the second image processing apparatus.

20. The non-transitory computer-readable recording medium as recited in claim 19, having a setting information registration program stored thereon, wherein the adjusted job execution condition is further registered as an additional information object on the second information processing apparatus, if the job execution condition being included in the target setting information object obtained from the target first image processing apparatus is not identical with the job execution condition based on the capability of the second image processing apparatus.

21. The non-transitory computer-readable recording medium as recited in claim 19, having a setting information registration program stored thereon, wherein a user's specified job execution condition not exceeding the capability of the second image processing apparatus is further registered as an additional information object on the second image processing apparatus, if the job execution condition being included in the target setting information object obtained from the target first image processing apparatus is not identical with the job execution condition based on the capability of the second image processing apparatus.

22. The non-transitory computer-readable recording medium as recited in claim 13, having a setting information registration program stored thereon, wherein the target setting information object is obtained from an LDAP server connected to the network, if it is not registered on the target first image processing apparatus.
